(19) United States
(12) Patent Application Publication
(10) Pub. No.: US 2002/0046492 A1
(43) Pub. Date: Apr. 25, 2002

(54) Potting arrangement and method using pumice

(76) Inventor: Jean Haas, Calgary (CA)

Correspondence Address: Thomas E. Malyszko, Patent and Trade Mark Agent, Suite 1500, 250-6 Ave. S.W., Calgary, AB, T2P 3H7, CA

(21) Appl. No.: 09/973,711

(22) Filed: Oct. 11, 2001

(30) Foreign Application Priority Data
Oct. 12, 2000 (CA) 2,323,288

(51) Int. Cl. A01G 25/00

(52) U.S. Cl. 47/79

(57) ABSTRACT

The present invention relates to a potting system for use with plants, and in particular for using a rock material in a novel potting arrangement and method for improved water and nutrient delivery to potted plants. The present system has two general aspects: the standard soil based growing medium in which the root ball of the plant sits; and, a reservoir for fluid that is continuously supplied to the plant via capillary action. This fluid is contained in a layer of inert, pH neutral pumice volcanic rock that has preferably been thoroughly washed. Due to the porosity and pore structure of the pumice material, it exhibits strong capillary action properties. This layer of pumice rock sits beneath the root ball of the plant in the base of the pot which lacks drainage holes. An overflow hole may be added a distance above the base of the pot to prevent drowning the root ball. Alternately, the plant, soil and pumice may be housed in a meshed bottom basket which may be inserted within the pot.

### FIELD OF THE INVENTION

The present invention relates to a potting system for use with plants, and in particular for using a rock material in a novel potting arrangement and method for improved water and nutrient delivery to potted plants.

### BACKGROUND OF THE INVENTION

Tropical and flowering plants are able to thrive and grow when supplied with adequate and timely delivery of light, temperature, water and nutrients. Plants absorb water and nutrients through their root systems, and current water delivery methods have limitations in effectiveness and ease of use. An alternative process providing significant gains in efficiency, consistency and conservation is presented further below.

There are currently two basic types of cultivation systems employed for household plants: 1) Soil based, and, 2) Soil-less (termed “hydroponics”).

1) Soil Based Cultivation

Soil based cultivation consists of a plant whose root system is contained within a growing medium of loam, peat moss and a variety of organic and inorganic soil amendments. The natural capacity of the growing medium as a nutrient source for the plant is augmented with additional fertilizer supplied either by mixing it in solid form into the medium itself or added with a water-soluble fertilizer. It is standard that the container, usually a pot made of plastic, ceramic or clay, is required to have at least one drain hole in the terminal or bottom end to facilitate drainage after watering to prevent root-rot and oxygen deprivation. Water and fertilizer are periodically administered from the top and the excess escapes through the drainage holes at the bottom end. Typically a catch tray is placed underneath the pot to prevent damage to underlying surfaces.

Some limitations with this methodology are as follows:

a) Frequent watering is required.

The growing medium does not typically retain more water than is required to completely wet the medium. The soil only has the capacity to retain the amount of water that completely wets the surface of each of the soil particles, which is small in proportion to the total volume of the soil. The plant usually consumes this water rapidly, requiring another watering cycle soon afterward, repeated ad-infinitum.

The hole(s) at the bottom end of the container allows excess water to drain out the bottom, preventing rot of the plant's root ball. While this is good for the roots of the plant, the user, or “gardener”, frequently under-waters the plant to prevent excessive spillage out the bottom of the container, since the only indication that complete wetting of the soil has taken place is by water leaving the pot out the drain hole. This leads to frequent watering of the plant and inconsistent soil moisture, with the gardener never really sure whether the plant is getting the requisite amount of water and nutrients. The soil is therefore typically either too wet or too dry.

In many cases, peat moss is the principle constituent of a traditional potting medium. This is almost always the case with nursery grown flowering plants. In such a system, the plant is wetted during the watering cycle as usual, but peat moss has a tendency to shrink when dry. If this occurs, then the potting medium pulls away from the sides of the container and when a watering cycle occurs, most of the water drains down along the inside walls of the pot, leaving very little wetting of the soil. The only way to then completely water the plant is to essentially submerge the entire root ball until completely soaked in another container of some kind that has been filled with water.

b) It's wasteful of both water and fertilizer.

Under normal circumstances, fertilizer is injected into the water during a watering cycle. Since the gardener typically supplies the plant with water until fluid is seen escaping the pot out the drain hole in the bottom, fertilizer is therefore also escaping out the bottom of the pot through the drain hole.

c) It's inefficient.

Because of the need to water the plant frequently with no real determination of a truly accurate amount of nutrient provided, and given that most plants require vastly different watering cycles, the gardener is left with the task of keeping an inordinate amount of information about which plants to water, when and how much. If any of the cycles are missed, the plant suffers greatly, and so many houseplants do not thrive. In the case of flowering houseplants, most people do not expect them to last more than a few weeks.

2) Non-soil (Hydroculture) Cultivation

Hydroculture is the term used for growing plants where the root system is contained in an inert, pH neutral growing medium. Water-soluble chemical fertilizer is the plant's sole or primary source of nutrients, and is introduced either as a solid during the initial planting in the inert growing medium, or on a period basis via watering.

Typically, the container used is a pot-within-a-pot system. The inner pot is typically a mesh or other water permeable material that allows water to enter and surround the inert growing medium. The outer pot is a closed vessel that acts as a reservoir for the nutrient solution.

Some advantages of this methodology are:

a) It's effective.

The roots of the plant are supplied with water and nutrient as they are absorbed by the inert growing medium. The plant has the ability to absorb as much or as little of the nutrient that it needs.

b) It's consistent.

The roots of the plant are continuously in contact with the appropriate amount of water and nutrient. The gardener also has the capacity to regulate the amount of water and nutrient that the plant is continuously in contact with. Further, pH requirements are easily regulated via the nutrient solution.

However, this method also has several disadvantages such as:

c) It's time consuming.

When a gardener wishes to transplant a plant that has been started in a traditional growing medium (such as potting soil), the gardener is required to: 1) remove all of the soil from the roots of the plant; 2) completely wash the roots of the plant; and, 3) very carefully re-pack the roots of the plant into the growing medium.

d) It's difficult to transplant a plant whose roots have completely filled the original container.

Transplanting from soil base to hydroculture is typically recommended for smaller plants. In cases where the root mass has entirely filled the growing container in a soil based medium, it is very difficult to transplant to hydroculture. Most nursery grown plants, and especially flowering houseplants, are sent to the retailer in rootbound condition.

What is therefore desired is a novel method and arrangement which overcomes the limitations and disadvantages of the existing cultivation systems, as set out herein.

### SUMMARY OF THE INVENTION

The present invention has most or all of the advantages of the two previously described methods. It incorporates an inert, readily available volcanic rock material to provide a plant that is growing in a traditional soil based medium the benefits of a continually watered hydroculture system.

The present system has two general aspects: 1) The standard soil based growing medium in which the root ball of the plant sits; and, 2) a reservoir for fluid that is continuously supplied to the plant via capillary action. This fluid is contained in a layer of inert, pH neutral pumice volcanic rock that has preferably been thoroughly washed. Due to the porosity and pore structure of the pumice material, it exhibits strong capillary action properties. This layer of pumice rock sits beneath the root ball of the plant in the base of the pot.

In the present system there are several important features to consider:

a) It is a single pot system.

The container of a first embodiment of the present invention differs from the usual soil based growing container in that no drain holes are provided at the bottom end of the container or pot. This allows for the pumice layer in the bottom portion of the pot to be filled with an appropriate amount of fertilized water, which is then readily available for supply to the plant. In a second embodiment of the invention, a meshed overflow drain hole is provided part way up the side of the pot, near the top of the pumice layer, for escape of excess water in the event that a user overfills the bottom portion to a level above the pumice layer. Alternately, the meshed overflow drain hole may be substituted with numerous smaller holes about the pot at the same level to avoid using a mesh. In a third embodiment, a perforated insert is placed within either of the first or second embodiments of the pot.

b) The water is delivered to the plant continuously, via capillary action.

As is the case in a hydroponic growing system, the water and nutrient are delivered to the plant in a continuous fashion, as required by the plant. The root ball of the plant draws water from the soil medium in which it is growing, which in turn causes the soil medium to draw water up from the pumice layer beneath it. The pumice layer supplies water to the growing medium via the naturally occurring capillary mechanism of the pumice material.

c) A plentiful amount of oxygen is supplied to the plant.

A vital component of growing plants is to supply the plant with enough oxygen. During the above-noted capillary action, the effect of water leaving the bottom reservoir and traveling up into the root ball draws ambient air down into the reservoir to fill the voids occupied earlier by the water. As well, the porosity of the pumice is such that it retains air. Hence, an abundant supply of oxygen is made available to the plant.

d) Water needs to be supplied only on a periodic basis.

Since the base of the pot of the present invention is closed, the pot can be filled to the top of the pumice layer with fertilized water. The plant sits directly above the pumice layer in the soil-growing medium. Since there is a large, continuous supply of water and nutrient at the base of the pot, the plant can flourish in an environment where watering cycles are less frequent. The plant only needs to be watered when the gardener determines that the reservoir in the base of the pot is dry or drying out. Water is evenly distributed throughout the pumice and the growing medium, and so dryness is easily determined by observation or feel of the topmost layer of the growing medium.

e) It's extremely effective.

The capillary action of the pumice rock provides the plant with an appropriate amount of water and nutrient all of the time (as long as there is water in the pumice layer) because the plant is drawing the water only on an as required basis. Instead of “drowning” the plant and then letting it dry (as in the above discussed prior art methods), the plant is allowed to determine and serve it's own water requirements, without any intervention from the gardener.

f) It doesn't waste anything.

Instead of the gardener having to guess at the right amount of water and fertilizer to supply to the plant in a given watering cycle, the base of the pot is simply filled to or near the top of the pumice layer. Water is not wasted by escape from the bottom end of the pot, and all of the supplied fertilizer is absorbed by the plant.

g) The plant is easy to transplant.

Any root bound nursery grown plant is easily transplanted. The gardener simply prepares a new container with the bed of pumice rock according to the present invention and then removes the plant from the old container, including the soil, and places the plant directly upon the pumice bed in the new container.

h) Spillage is avoided.

In one embodiment of the pot there is no water runoff after the watering cycle, and so the gardener is free to place the plants wherever desireable without fear of water damage to the supporting base, such as good furniture, wooden table tops, etc.

i) Fertilizer may be pre-applied.

A water-soluble slow-release fertilizer may be added to the pumice (whether washed or not) for absorption by the soil and the plant. The pumice layer therefore forms a desireable nutrient reservoir.

### BRIEF DESCRIPTION OF THE DRAWING FIGURES

Embodiments of the invention will now be described, by way of example only, with reference to the accompanying drawings, wherein:

FIG. 1 shows an elevated cross-sectional view of a potting arrangement and method according to a first preferred embodiment of the present invention;

FIG. 2 is a view similar to FIG. 1 showing a second embodiment of the invention wherein a meshed drain hole is provided above the base of the pot;

FIG. 3 is a cross-sectional view of a third embodiment of the invention showing a perforated insert placed within a pot lacking a drain hole as in FIG. 1; and,

FIG. 4 is a transparent view of the insert of FIG. 3 showing a layer of pumice within the insert, and in addition illustrates an alternate version of the third embodiment wherein numerous small drain holes are provided above the base of the pot.

### LIST OF REFERENCE NUMERALS

10 plant stem

12 roots or root system

14 water

16 water source

20 pot

22 base of 20

24 sidewalls of 20

26 bottom portion of 20

28 top portion of 20

30 pumice rock

32 soil

34 water flow through 32

36 water migration from 26 & 30 to 32 & 12

40 drain hole

42 mesh of 40

44 smaller drain holes without mesh

50 insert

52 solid upper wall portion of 50

54 perforated lower portion of 50

### DESCRIPTION OF EMBODIMENTS OF THE INVENTION

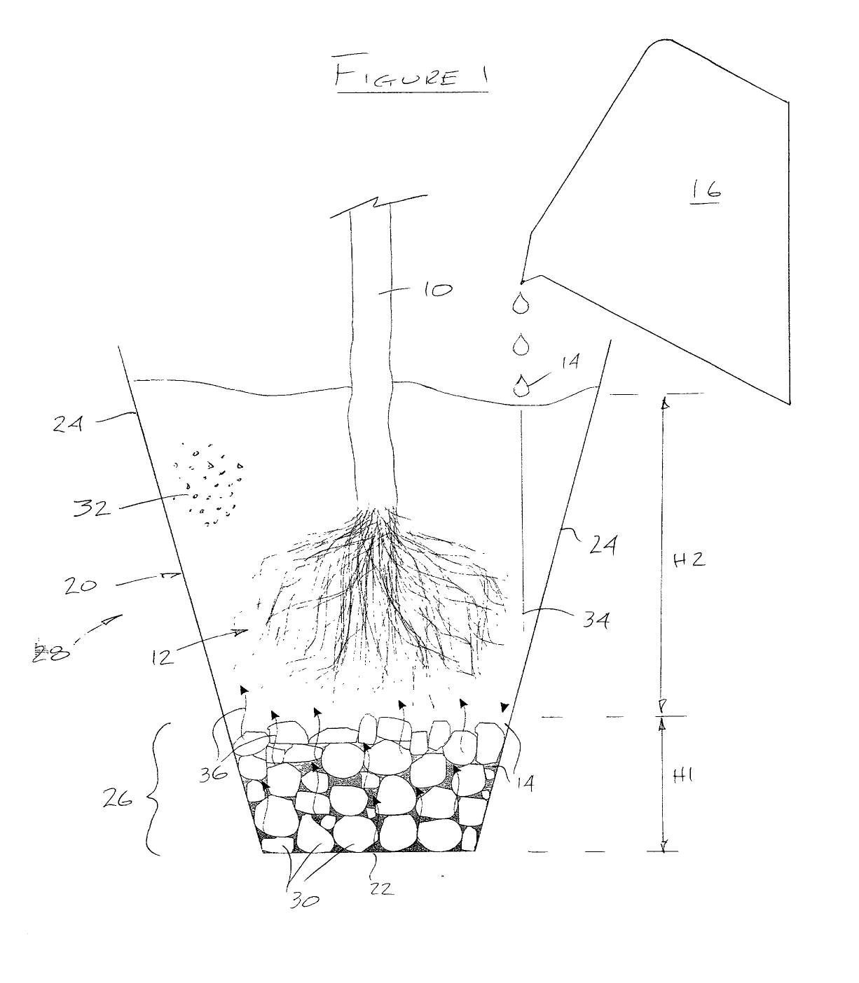

With reference to FIG. 1, a stem or stalk 10 of a plant with a root system or ball 12 is shown located, or “potted”, in a potting arrangement according to one embodiment of the present invention. The potting arrangement includes a pot 20, which may also be referred to and known as a container, vessel, or the like, having a base 22 and outwardly sloped sidewalls 24. The pot 20 is of a common and popular shape for illustrative purposes, but it will be appreciated that various shapes and configurations will be suitable for use herewith. An important difference of the pot 20 over prior art pots used in soil based cultivation is that the pot 20 lack or omits any water drainage holes or outlets in the base 22 and elsewhere. Hence, whereas prior art pots for soil based cultivation require a form of water drainage outlet in the base to prevent root decay or rot, the present pot 20 is designed to contain any water 14 in a bottom portion 26 thereof, as applied from a watering source 16 for instance. It is understood that the term “water” includes any liquid suitable for use with plants which may or may not contain fertilizer or other soluble and non-soluble plant nutrients.

In the potting system of the present invention., a layer of crushed pumice rock 30 is laid out in the bottom potion 26 of the pot as shown, to form a water “reservoir”. Good results have been achieved with pumice rock of between ⅜ inch to ¾ inch diameter. The root ball (i.e. roots and surrounding soil) of the plant to be potted is then inserted into the pot above the pumice layer in a top portion 28 of the pot, and additional potting soil 32 or like plant growth medium is added around the root ball to fill the pot as desired. The soil is not to be mixed with the pumice rock 30. The soil and pumice rock are kept in distinct layers as much as possible, although over time some soil will migrate into the pumice rock zone. For optimum performance, the pumice rock should be thoroughly cleaned by washing away silt or other materials which might be clogging the pores of the rock, prior to placing the rock into the pot. The volume of rock provided depends somewhat on the frequency of watering desired by the user—less rock being provided for more frequent watering, and vice versa. Typically, however, when using a pot of the type shown in FIG. 1, the height of the pumice layer H1 should be a minimum of about ¼ of the height H2 of the soil layer 32.

Once the plant 10 has been potted as described above, it may be watered from the water source 16 in the same manner as any soil based system. However, in the instant case, enough water should be provided so that the water will flow through the soil (as indicated by arrow 34) to not only wet the soil 30 but soak the pumice 30 by substantially filling the pumice reservoir 26 with water. As a rule of thumb, the user should add a volume of water which is half of the volume of pumice placed at the bottom of the pot so as not to overfill the bottom portion 26. For example, a 500 ml bed of pumice should hold about 250 ml water. Over time the user will develop a “feel” for the watering requirement as the user gets acquainted with the present system.

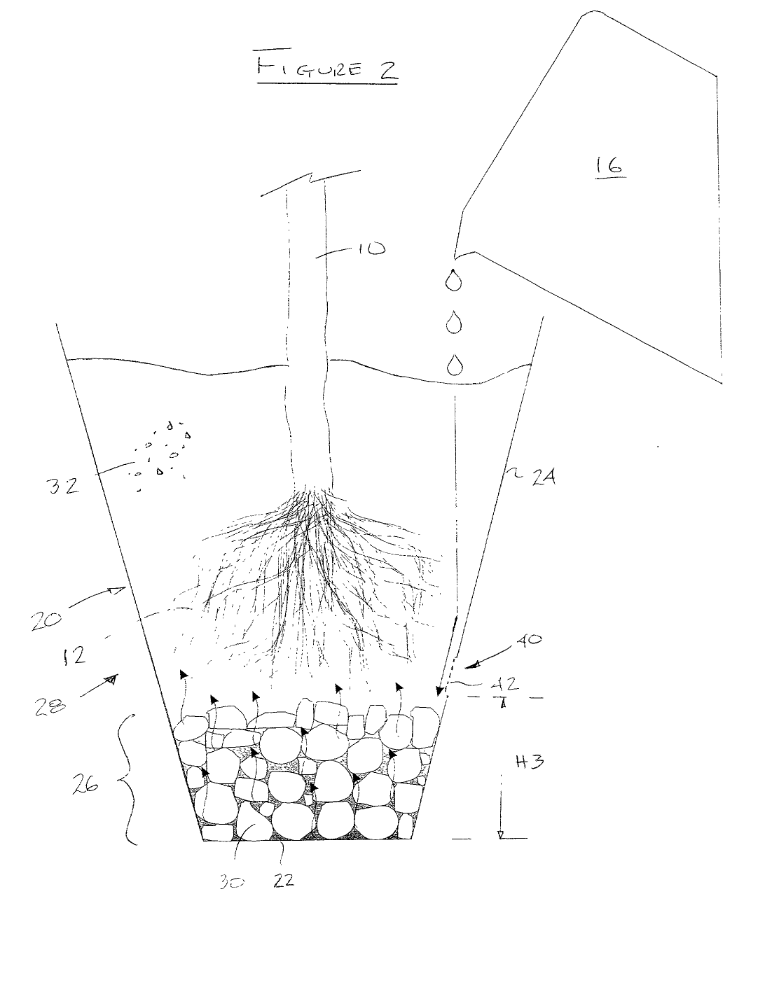

In a second embodiment of the invention shown in FIG. 2, a drain hole 40 is provided in the sidewall 24 of the pot. In this embodiment the same reference numerals are used to identify the same or substantially similar elements from the first embodiment. The drain hole 40 is preferably located just above the pumice rock layer, namely at a height H3 of about ¼ to ⅓ of the total height of the pot (which is at least H1+H2 in FIG. 1). The drain hole 40 ensures that a user can fill the bottom portion 26 with water without over-filling the pot, so as to avoid drowning the roots 12 and soil 32 above the pumice rock. Hence, in the event that a user overfills the base while watering to a level above the pumice layer in the bottom portion 26, the excess water merely escapes through the overflow drain hole 40. A mesh 42 should be placed in the hole to discourage escape of the soil 32. It will be appreciated that the size of the drain hole may be varied, depending on the rate of water escape desired. More that one drain hole may be provided about the pot if required.

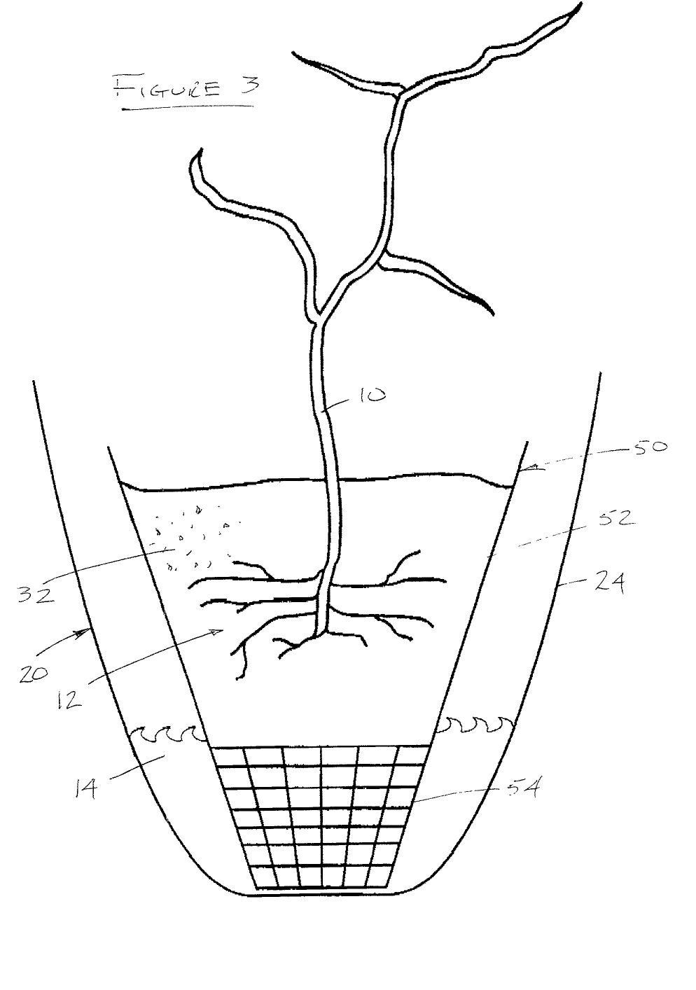

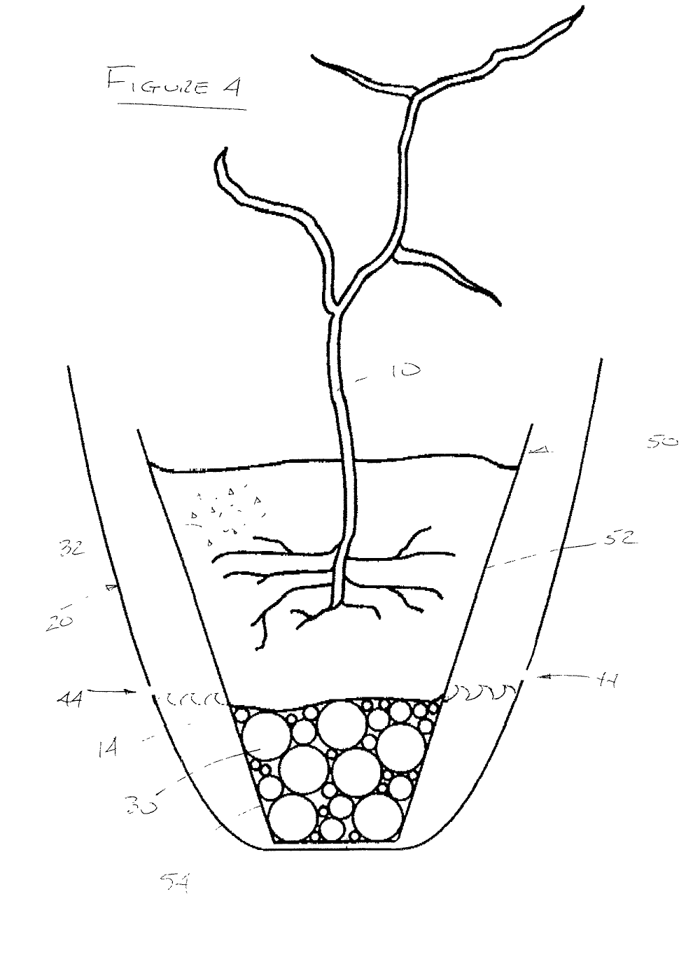

In a third embodiment of the invention shown in FIGS. 3 and 4, an insert 50, or “basket”, is placed within the pot 20. In this embodiment the same reference numerals are used to identify the same or substantially similar elements from the first and second embodiments. The insert has an upper portion with sloped solid walls 52 for holding the soil 32 and root ball 12, and a meshed or perforated sloped lower portion 54 below portion 52 for holding the layer of pumice 30. Water 14 should be added to the pot to about the top of the pumice layer, namely to the upper extent of the meshed portion 54. The pumice therefore draws water to the soil and root ball as in the earlier embodiments. An advantage of this embodiment is that the insert may be readily lifted out of the pot to check for the presence of water in the pot, and for the quantity or level of that water. God results have been achieved using commercially available containers used in the hydroponic industry. An alternate version of this embodiment shown in FIG. 4 illustrates how numerous smaller holes 44 may be spaced about the perimeter of the pot at about the same level as drain hole 40 (shown in FIG. 2) to avoid overfilling the pot. The smaller holes should avoid the need for a mesh therein.

The many advantages of the present system, as described earlier, may now be better appreciated. In particular, it is noted the water is delivered to the plant continuously (as indicated by arrows 36), via capillary action of the pumice rock. The root ball 12 of the plant draws water from the soil 32 in which it is growing, which in turn causes the soil 32 to draw water up from the layer 26 of pumice 30 beneath. The pumice layer supplies water to the soil via the naturally occurring capillary mechanism of the pumice material. A user need only ensure that enough water is delivered on a periodic basis to keep the pumice wet, as noted earlier. A signal to provide more water is when the soil at the top of the pot starts drying out. The pumice layer also provides a “safety valve” regarding over-watering in that if too much water is provided (i.e. more than can be absorbed by the pumice rock), then the excess water will merely accumulate and sit in the bottom portion 26 of the pot, away from the root ball 12. As the pumice then releases water to the soil, the excess water will be absorbed by the pumice rock for future release to the soil as required by the plant.

Experience shows that, over time, some roots emerge from the root ball 12 and do grow into the pumice layer, but that such particular new root growth thrives in the pumice layer and does not rot. Eventually (say, in about one year or so), as is the case with many growing plants, the plant 10 must be replanted into a bigger pot, preferably using the same pumice potting arrangement.

Experiments also indicate that improved plant health and/or growth may be achieved by adding a slow-release fertilizer to the pumice rock after it has preferably been washed, as described earlier, to form a nutrient reservoir. The fertilizer is delivered to the plant as water is drawn up from the pumice rock. It is noted that in some applications the pumice need not be washed, particularly where harder varieties of pumice are used.

The above description is intended in an illustrative rather than a restrictive sense, and variations to the specific configurations described may be apparent to skilled persons in adapting the present invention to other specific applications. Such variations are intended to form part of the present invention insofar as they are within the spirit and scope of the claims below. For instance, the insert 50 with the pumice layer 30 may be used in a larger hydroponic type setting, namely a number of inserts may be placed in a large pool of water (which is analogous to having a very large pot 20).

I claim:

1. A potting arrangement and method using pumice as described and illustrated herein.
